(19) United States
(12) Patent Application Publication
(10) Pub. No.: US 2020/0371468 A1
(43) Pub. Date: Nov. 26, 2020

(54) IMAGE FORMING APPARATUS

(71) Applicant: KYOCERA Document Solutions Inc., Osaka (JP)

(72) Inventors: Yuki UOHASHI, Osaka (JP); Masahiko MIZUNO, Osaka (JP)

(21) Appl. No.: 16/879,063

(22) Filed: May 20, 2020

(30) Foreign Application Priority Data
May 21, 2019 (JP) 2019-095512

(51) Int. Cl. G03G 21/16

(52) U.S. Cl. CPC G03G 21/1647; G03G 21/1633

(57) ABSTRACT

An image forming apparatus includes an image forming apparatus body, a photosensitive drum, a developing part developing an electrostatic latent image formed on a peripheral surface of the photosensitive drum into a toner image by supplying a toner, a transfer part transferring the toner image from the peripheral surface of the photosensitive drum onto a sheet, and a fixing part fixing the toner image transferred on the sheet. The photosensitive drum, the developing part, the transfer part, and the fixing part are unitized as an image-formation-related unit and the image-formation-related unit is detachably housed in the image forming apparatus body.

### CROSS-REFERENCE TO RELATED APPLICATION(S)

This application is based upon and claims the benefit of priority from Japanese Patent Application No. 2019-095512 filed on May 21, 2019, the entire contents of which are incorporated herein by reference.

### BACKGROUND

The technology disclosed herein relates to an image forming apparatus.

An electrophotographic image forming apparatus has been known which includes an image forming unit configured by unitizing a photosensitive drum and peripheral devices arranged around the photosensitive drum. The peripheral devices include a charging part, a developing part, and a transfer part. The image forming unit is detachably housed in an image forming apparatus body that has a conveying mechanism, etc. The image forming unit forms a toner image on a sheet fed from a sheet feeding unit. A fixing device that fixes the toner image on the sheet by heating and pressing is arranged on the downstream side of the image forming unit in the sheet conveying direction.

### SUMMARY

An aspect of the present disclosure provides an image forming apparatus including an image forming apparatus body, a photosensitive drum, a developing part, a transfer part, and a fixing part. The developing part develops an electrostatic latent image formed on a peripheral surface of the photosensitive drum into a toner image by supplying a toner. The transfer part transfers the toner image from the peripheral surface of the photosensitive drum onto a sheet. The fixing part fixes the toner image transferred on the sheet. The photosensitive drum, the developing part, the transfer part, and the fixing part are unitized as an image-formation-related unit. The image-formation-related unit is detachably housed in the image forming apparatus body.

### BRIEF DESCRIPTION OF THE DRAWINGS

FIG. 1 is a diagram schematically illustrating a configuration of an image forming apparatus according to an embodiment of the present disclosure;

FIG. 2 is an enlarged view illustrating an image-formation-related unit;

FIG. 3 is a view as viewed in the direction indicated by arrow III in FIG. 2;

FIG. 4 is a sectional view taken along line IV-IV in FIG. 2;

FIG. 5 is a sectional view taken along line V-V in FIG. 2;

FIG. 6 is a diagram corresponding to FIG. 1, with a maintenance opening of an image forming apparatus body opened;

FIG. 7 is a diagram corresponding to FIG. 1, with the image-formation-related unit detached from the image forming apparatus body;

FIG. 8 is a diagram corresponding to FIG. 1, with only a fixing unit detached from the image forming apparatus body;

FIG. 9 is a diagram corresponding to FIG. 1, with a door formed on a right side surface of the image forming apparatus body opened; and

FIG. 10 is a diagram corresponding to FIG. 1, with a toner container removed from the image forming apparatus body.

### DETAILED DESCRIPTION

Hereinafter, an example embodiment of the present disclosure will be described in detail on the basis of the drawings. It should be understood that the technology disclosed herein is not limited to the embodiment described below.

### Embodiment

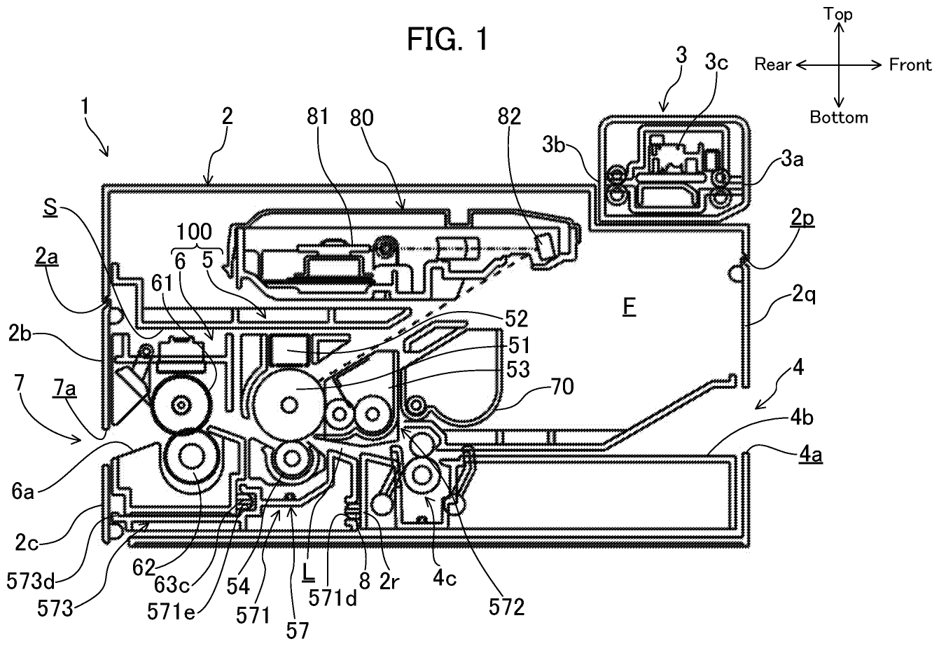

FIG. 1 is a sectional view schematically illustrating a configuration of an image forming apparatus 1 according to this embodiment. Note that the terms “front”, “rear”, “left”, and “right” in the following description are defined with respect to the image forming apparatus 1 and conform to the directional axis definition shown in the figures.

The image forming apparatus 1 includes an image forming apparatus body 2 having a rectangular parallelepiped shape in appearance, and a scanner device 3 mounted on a top surface of the image forming apparatus body 2. The scanner device 3 has a document inlet 3a, a document outlet 3b, and a contact image sensor 3c arranged between the document inlet 3a and the document outlet 3b. A document is fed into the scanner device 3 through the document inlet 3a. The scanner device 3 reads an image of the document with the contact image sensor 3c to generate image data of the document. The scanner device 3 transmits the generated image data of the document to a control unit (not illustrated) provided in the image forming apparatus body 2.

The image forming apparatus body 2 includes a manual sheet feeding unit 4, an image forming unit 5, a fixing unit (fixing part) 6, and a sheet discharging unit 7. The image forming apparatus body 2 forms an image on a sheet on the basis of given image data while conveying the sheet along a conveyance path L in the image forming apparatus body 2. The image data is composed of document image data read by the scanner device 3 or data transmitted from a terminal (not illustrated) or the like, e.g., a computer.

The manual sheet feeding unit 4 includes a sheet inlet 4a formed to open to a front side surface of the image forming apparatus body 2, a guide tray 4b, and a pair of sheet feed rollers 4c arranged adjacently to a rear end (a downstream-side end in the sheet conveying direction) of the guide tray 4b. The pair of sheet feed rollers 4c nip and convey a sheet manually fed into the guide tray 4b through the sheet inlet 4a so that the sheet is fed into the image forming unit 5.

The image forming unit 5 is arranged adjacently to the pair of sheet feed rollers 4c at the rear of the pair of sheet feed rollers 4c. The image forming unit 5 includes a photosensitive drum 51 as an image carrier. Around the photosensitive drum 51, a charger 52, a developing part 53, and a transfer roller (transfer part) 54 are disposed. The photosensitive drum 51 and the devices disposed around the photosensitive drum 51 (i.e., the charger 52, the developing part 53, and the transfer roller 54) are unitized by means of a casing frame 57.

Further, an optical scanning device 80 is disposed above the photosensitive drum 51. The optical scanning device 80 includes a polygon mirror 81 deflecting and scanning a laser beam emitted from a light source (not illustrated), and a turning mirror 82 reflecting a deflected and scanned light beam toward a surface of the photosensitive drum 51.

The image forming apparatus body 2 has a receiving space F therein that is arranged at the front of the image forming unit 5 and receives a toner container 70. The toner container 70 contains a toner to be used in developing. The image forming apparatus body 2 has an opening 2p formed in the front side surface thereof, which is used for replacing the toner container 70. The opening 2p is openably closed by a door 2q. The opening 2p is opened by turning the door 2q upward about its upper end. By opening the door 2q, an operator is allowed to perform replacement of the toner container 70.

The fixing unit 6 is arranged adjacently to the image forming unit 5 at the rear of the image forming unit 5. The fixing unit 6 includes a fixing roller 61 and a pressure roller 62 that are rotated in a state of being pressed against each other. The fixing unit 6 heat-fixes a toner image, which is transferred onto a sheet in the image forming unit 5, on the sheet. The fixing unit 6 together with the image forming unit 5 constitute an image-formation-related unit 100, which is described later.

The sheet discharging unit 7 includes a sheet outlet 7a formed in a rear side surface of the image forming apparatus body 2. The sheet outlet 7a is arranged adjacently to a downstream-side end of a sheet guide surface 6a of the fixing unit 6. A sheet subjected to the heat-fixing is guided to the sheet outlet 7a by the sheet guide surface 6a.

Next, an image forming operation performed in the image forming apparatus 1 is generally described. Once the image forming apparatus 1 receives image data, the photosensitive drum 51 of the image forming unit 5 is rotationally driven and the surface of the photosensitive drum 51 is electrically charged by the charger 52. Further, the optical scanning device 80 applies a laser beam based on the image data to the electrically charged surface of the photosensitive drum 51.

Thereby, an electrostatic latent image corresponding to the image data is formed on the surface of the photosensitive drum 51. The electrostatic latent image formed on the surface of the photosensitive drum 51 is developed with an electrically charged toner in the developing part 53 so that it is visualized as a toner image. When a sheet passes between transfer roller 54 and the photosensitive drum 51, the toner image migrates to the sheet due to a transfer bias that has a polarity opposite to that of the toner. Thus, the toner image is transferred from the photosensitive drum 51 onto a sheet. The sheet having the toner image transferred thereon is heated and pressed by the fixing roller 61 and the pressure roller 62 in the fixing unit 6. Thereby, the toner image is fixed on the sheet. The sheet having the toner image fixed thereon is sent downstream by the fixing roller 61 and the pressure roller 62 and discharged out of the image forming apparatus body 2 through the sheet outlet 7a.

### Configuration of Image-Formation-Related Unit 100

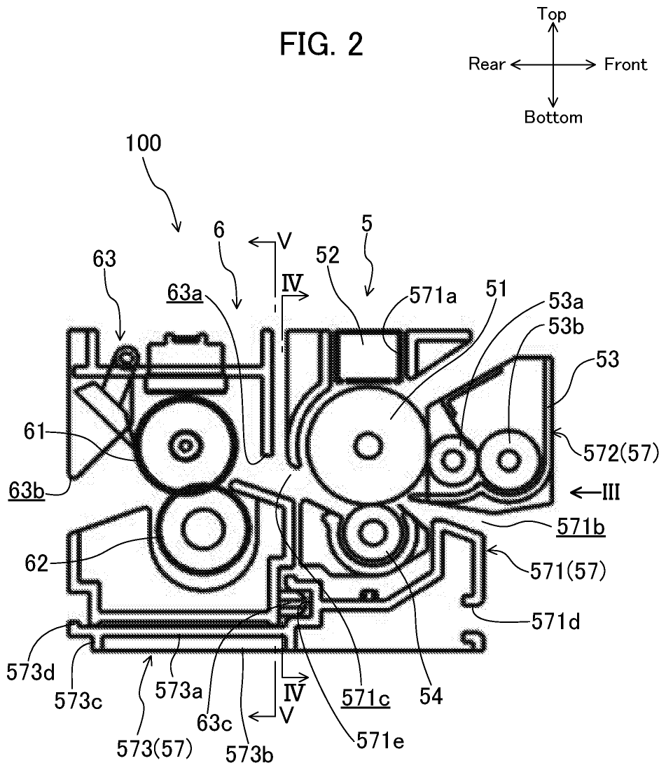

As shown in FIGS. 1 and 2, the image forming unit 5 and the fixing unit 6 are unitized as an image-formation-related unit 100 by means of a casing frame 57. The image-formation-related unit 100 is received in a receiving space S arranged at the rear of the pair of sheet feed rollers 4c in the image forming apparatus body 2. The image forming apparatus body 2 has a maintenance opening 2a formed in the rear side surface thereof, which communicates with the receiving space S. The maintenance opening 2a is opened and closed by an upper door 2b and a lower door 2c. The upper door 2b is configured to turn about its upper end, while the lower door 2c is configured to turn about its lower end. The upper door 2b and the lower door 2c are formed such that only the sheet outlet 7a is exposed between the upper and lower doors 2b and 2c when they are closed. By opening the upper door 2b and the lower door 2c, an operator is allowed to access the image-formation-related unit 100 received in the receiving space S.

As shown in FIG. 2, the casing frame 57 has a casing body part 571, a developing housing part 572, and a fixing support part 573. The casing body part 571 is formed to have a rectangular parallelepiped shape in appearance, which extends in the left-right direction. The casing body part 571 houses the photosensitive drum 51 and the transfer roller 54. The casing body part 571 has an opening 571a formed in a top wall thereof, in which the charger 52 is fitted. The casing body part 571 has a sheet receiving port 571b and a sheet discharging port 571c formed in a front side surface and a rear side surface thereof, respectively. The sheet receiving port 571b receives a sheet fed from the pair of sheet feed rollers 4c. The sheet discharging port 571c discharges a sheet having passed between the photosensitive drum 51 and the transfer roller 54 and having a toner image transferred thereon.

The developing housing part 572 is integrally formed on the front side surface of the casing body part 571 at a position higher than the sheet receiving port 571b. The developing housing part 572 is formed in a hollow case shape which extends along the entire casing body part 571 in the left-right direction. The developing housing part 572 houses constituent parts, such as a developing roller 53a and a stirring roller 53b, of the developing part 53.

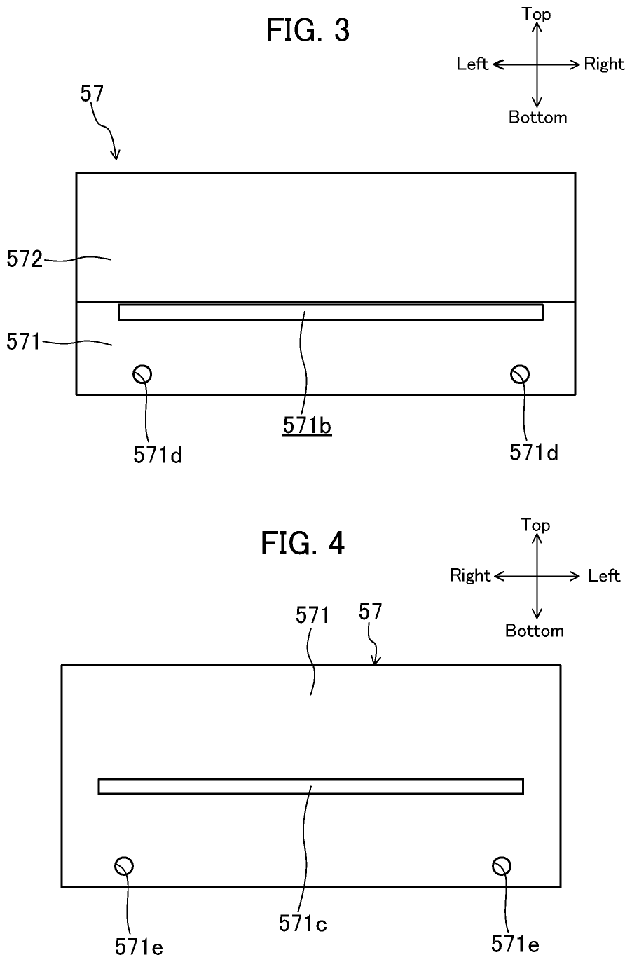

As shown in FIG. 3, the casing body part 571 has a pair of positioning holes 571d formed in the front side surface thereof at a position lower than the sheet receiving port 571b. The pair of positioning holes 571d are spaced from each other in the left-right direction. The pair of positioning holes 571d are respectively engaged with a pair of positioning pins 8 provided in the image forming apparatus body 2, thereby positioning the image-formation-related unit 100 in the left-right direction. As shown in FIG. 1, the pair of positioning pins 8 protrude rearward from a positioning plate 2r that is erected at the rear of the pair of sheet feed rollers 4c.

The fixing support part 573 (see FIG. 2) is integrally formed on a lower end portion of the rear side surface of the casing body part 571. The fixing support part 573 supports the fixing unit 6 from below. Specifically, as shown in FIG. 2, the fixing support part 573 has a support plate part 573a and a base plate part 573b that extend rearward from the rear side surface of the casing body part 571. A lower surface of the base plate part 573b is continuously connected to a bottom surface of the casing body part 571 such that it is flush therewith. The support plate part 573a is disposed above the base plate part 573b with a space therebetween. A rear end portion of the lower surface of the support plate part 573a is coupled to the base plate part 573b via a leg part 573c. Thus, the fixing support part 573 has a double-plate structure formed by the support plate part 573a and the base plate part 573b. An upper surface of the support plate part 573a forms a mount surface on which the fixing unit 6 is mounted. A handle part 573d is formed on a rear end of the support plate part 573a. The handle part 573d protrudes upward slightly from the upper surface of the support plate part 573a so that an operator can hook his/her finger thereon.

FIG. 4 is a sectional view taken along line IV-IV in FIG. 2. As shown in FIG. 4, the casing body part 571 has a pair of positioning holes 571e formed in a lower end portion of the rear side surface thereof, which are used for positioning the fixing unit 6 in the left-right direction. The pair of positioning holes 571e are formed at a position slightly higher than the upper surface of the support plate part 573a (see FIG. 2) and are spaced from each other in the left-right direction. The pair of positioning holes 571e are respectively fitted on a pair of positioning protrusions 63c formed on the fixing unit 6.

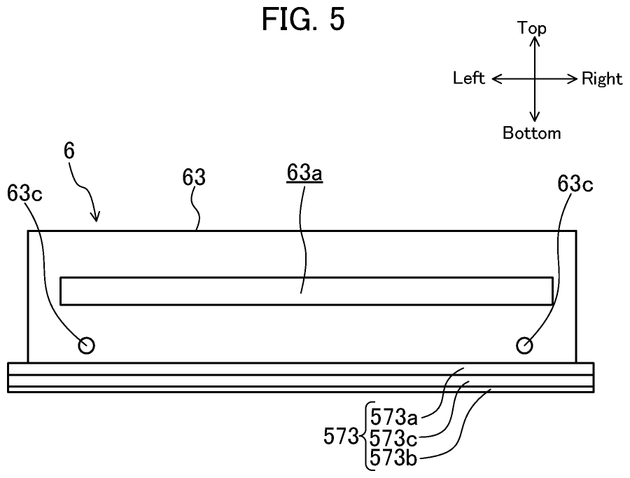

FIG. 5 is a sectional view taken along line V-V in FIG. 2. As shown in FIG. 5, the fixing unit 6 has a fixing housing 63 that houses the fixing roller 61 and the pressure roller 62. The fixing housing 63 is formed in a rectangular box shape which extends in the left-right direction. The fixing housing 63 has a sheet receiving port 63a formed in a front side surface thereof and has a sheet discharging port 63b (see FIG. 2) formed in a rear side surface thereof. The pair of positioning protrusions 63c are formed on a lower end portion of the front side surface of the fixing housing 63 and are spaced from each other in the left-right direction. As shown in FIG. 2, the pair of positioning protrusions 63c are engaged with the pair of positioning holes 571e of the casing frame 57, thereby positioning the fixing unit 6 so that the fixing unit 6 is unmovable in the left-right direction. The fixing unit 6 can be detached separately from the image forming unit 5 by sliding the fixing unit 6 in the state shown in FIG. 2 rearward.

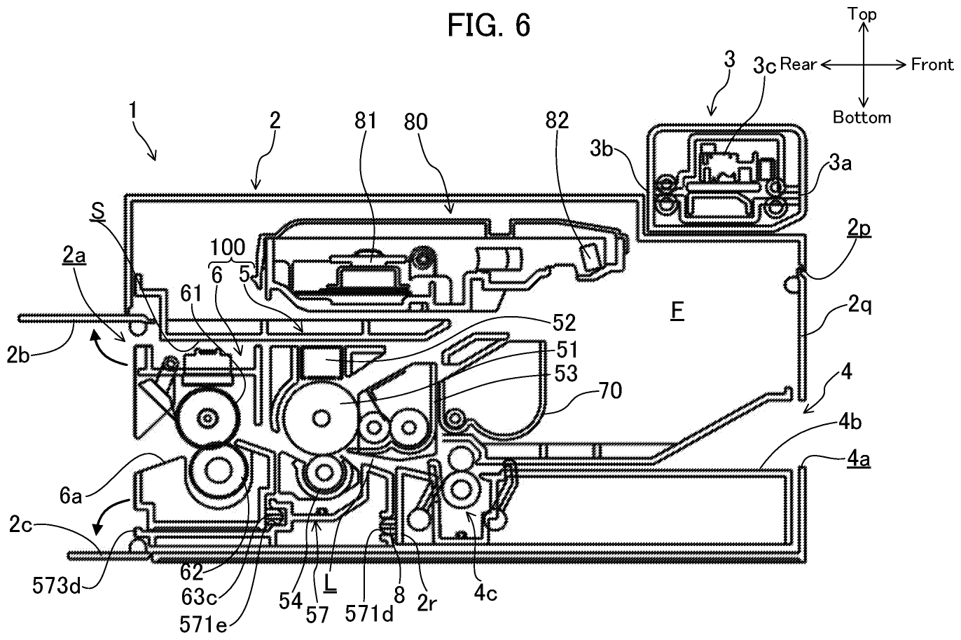

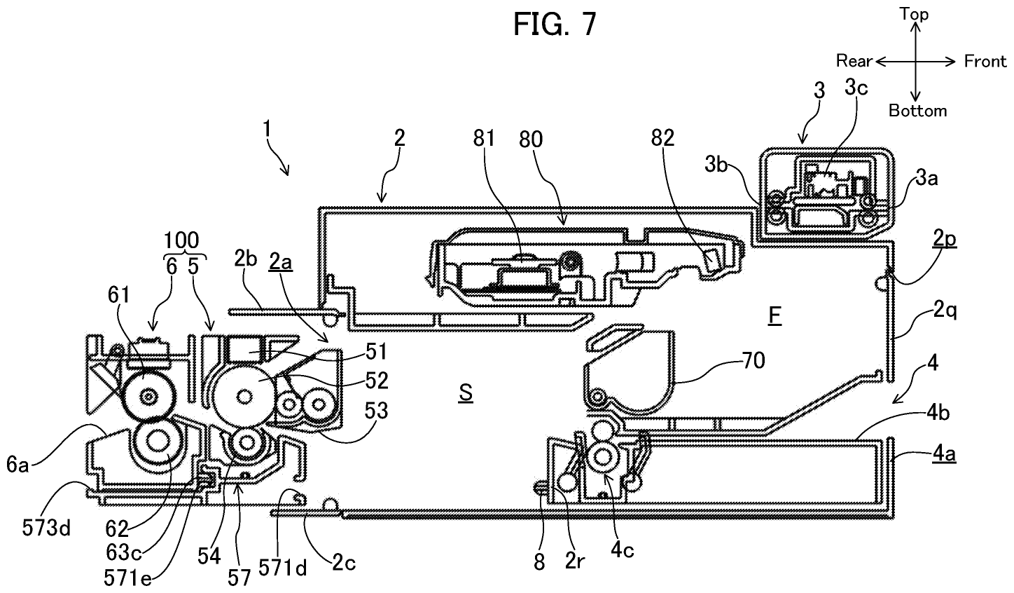

Next, detachment and attachment of the image-formation-related unit 100 are described with reference to FIGS. 6 and 7. To detach the image-formation-related unit 100 from the image forming apparatus body 2, an operator first turns the upper door 2b and the lower door 2c respectively in the directions indicated by the bold arrows in FIG. 6 to open the maintenance opening 2a. Subsequently, the operator grips the handle part 573d, which is formed on the rear end of the casing frame 57, with his/her hand and pulls out the casing frame 57 rearward through the maintenance opening 2a. Thereby, the whole image-formation-related unit 100 is pulled out of the image forming apparatus body 2 as shown in FIG. 7. On the other hand, to attach the image-formation-related unit 100 into the image forming apparatus body 2, the operator first adjusts the position of the casing frame 57 in the left-right direction to cause the positions of the pair of positioning holes 571d in the left-right direction to correspond to the positions of the pair of positioning pins 8 in the left-right direction. After the adjustment of the position of the casing frame 57 is completed, the operator pushes the casing frame 57 forward, thereby sliding the whole image-formation-related unit 100 forward. The operator stops the sliding of the image-formation-related unit 100 when the front side surface of the casing frame 57 is brought into contact with the positioning plate 2r in the image forming apparatus body 2. Thereafter, the operator closes the upper door 2b and the lower door 2c, so that the image-formation-related unit 100 is sandwiched and fixed between the positioning plate 2r and the upper and lower doors 2b and 2c (see FIG. 1). Thereby, the image-formation-related unit 100 is positioned in the front-rear direction, upon which the attachment of the image-formation-related unit 100 is ended.

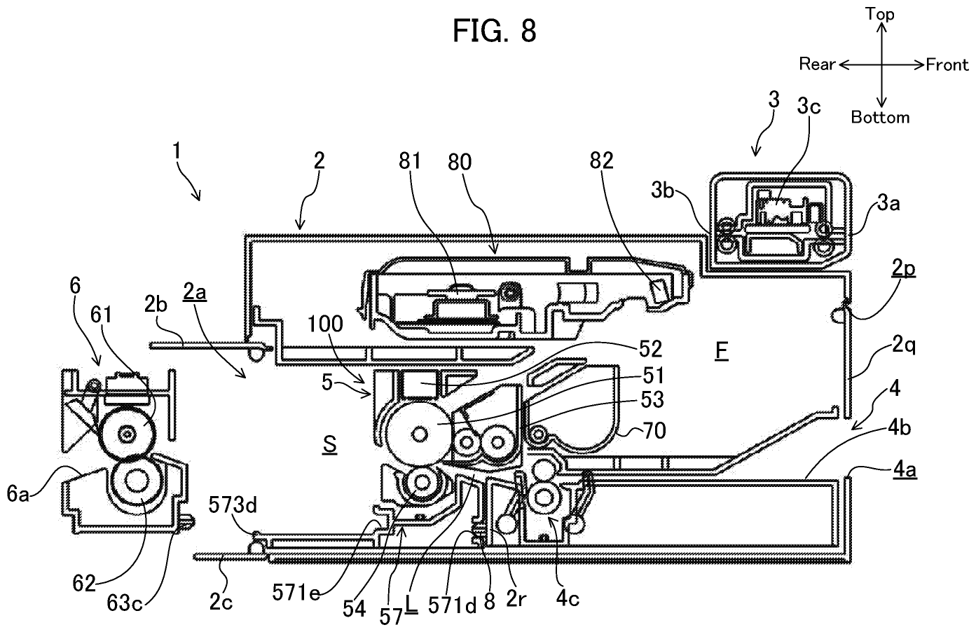

FIG. 8 shows a state where only the fixing unit 6 is detached from the image forming apparatus body 2. To detach only the fixing unit 6, the operator first opens the upper and lower doors 2b and 2c as shown in FIG. 6, and then slides the fixing unit 6 rearward. Thereby, the pair of positioning protrusions 63c of the fixing unit 6 are pulled out of the pair of positioning holes 571e of the casing frame 57, so that only the fixing unit 6 is detached from the image forming apparatus body 2.

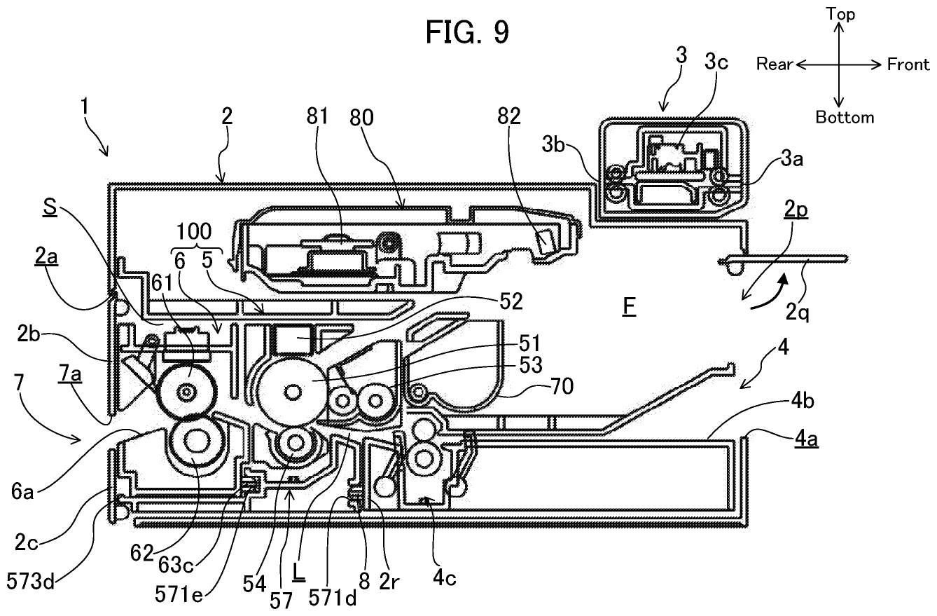

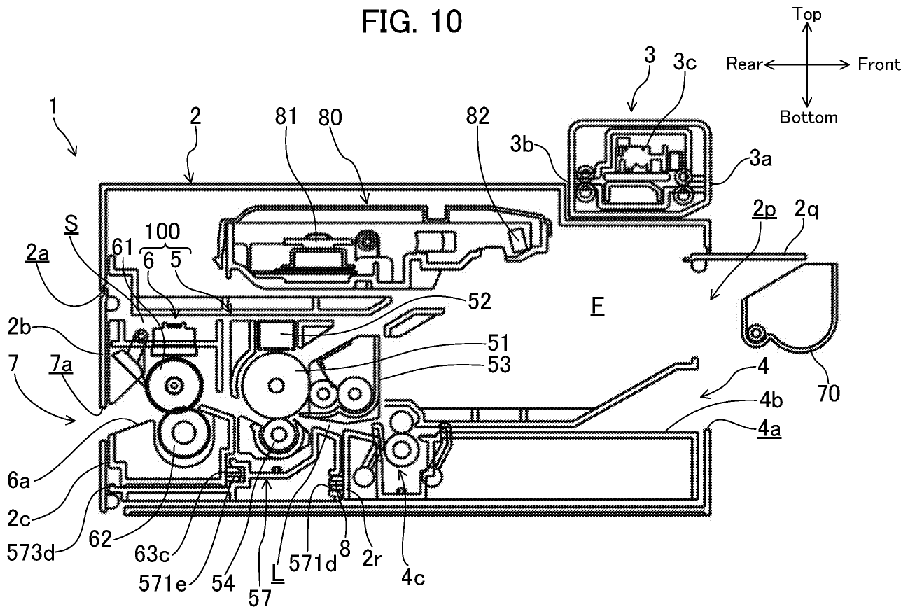

Next, a procedure for replacing the toner container 70 is described with reference to FIGS. 9 and 10. To replace the toner container 70, as shown in FIG. 9, the operator turns the door 2q formed on the right side surface of the image forming apparatus body 2 in the direction indicated by the bold arrow in FIG. 9. Thereby, the opening 2p is opened so that the toner container 70 can be removed out of the image forming apparatus body 2 (see FIG. 10).

### Operational Effects

As described above, in this embodiment, the photosensitive drum 51, the developing part 53, the transfer roller 54, and the fixing unit 6, which are related to image formation and each have a shorter life than the image forming apparatus body 2, are unitized as an image-formation-related unit 100. With this configuration, since the image-formation-related unit 100 as a whole can be detached from the image forming apparatus body 2, the user can easily carry out replacement of an image-formation-related device which has reached the end of its life (i.e., a maintenance operation).

Further, the image-formation-related unit 100 in this embodiment consists of the image forming unit 5 and the fixing unit 6 and is configured such that the fixing unit 6 can be independently detached.

With this configuration, for example, when sheet jam occurs between the image forming unit 5 and the fixing unit 6, detaching only the fixing unit 6 allows the user to easily deal with the sheet jam.

Further, in this embodiment, the image-formation-related unit 100 is configured separately from the toner container 70 and the toner container 70 can be replaced independently of and separately from the image-formation-related unit 100.

With this configuration, since the toner container 70 that needs more frequent replacement than the other components can be replaced independently, maintenance of the image forming apparatus 1 is more facilitated.

### Other Embodiments

In the above-described embodiment, the image-formation-related unit 100 is configured to be detached from and attached to the image forming apparatus body 2 by moving the image-formation-related unit 100 in the front-rear direction with respect to the image forming apparatus body 2. However, the present disclosure is not limited to this configuration and the image-formation-related unit 100 may be configured to be detached from and attached to the image forming apparatus body 2 by moving the image-formation-related unit 100 in the top-bottom direction or in the left-right direction with respect to the image forming apparatus body 2.

In the above-described embodiment, the image forming unit 5 is configured by unitizing the photosensitive drum 51, the charger 52, the developing part 53, and the transfer roller 54. However, the image forming unit 5 may further include, for example, a discharger. Further, the image forming unit 5 may further include, for example, a cleaning device which clears a residual toner from the surface of the photosensitive drum 51. That is to say, the image forming unit 5 only has to include at least the photosensitive drum 51, the developing part 53, and the transfer roller (transfer part) 54.

What is claimed is:

1. An image forming apparatus, comprising:
an image forming apparatus body;
a photosensitive drum;
a developing part configured to develop an electrostatic latent image formed on a peripheral surface of the photosensitive drum into a toner image by supplying a toner;
a transfer part configured to transfer the toner image from the peripheral surface of the photosensitive drum onto a sheet; and
a fixing part configured to fix the toner image transferred on the sheet,
wherein:
the photosensitive drum, the developing part, the transfer part, and the fixing part are unitized as an image-formation-related unit; and
the image-formation-related unit is detachably housed in the image forming apparatus body.

2. The image forming apparatus of claim 1, wherein:
the image-formation-related unit consists of an image forming unit and a fixing unit, the image forming unit being configured by unitizing the photosensitive drum, the developing part, and the transfer part, the fixing unit being configured by unitizing the fixing part; and
the image-formation-related unit is configured such that the fixing unit can be independently detached separately from the image forming unit.

3. The image forming apparatus of claim 1, wherein:
the image forming apparatus further comprises a toner container housed in the image forming apparatus body and configured to contain the toner;
the image-formation-related unit is configured separately from the toner container; and
the toner container is configured to be replaceable independently of the image-formation-related unit.
